(19) United States
(12) Patent Application Publication
(10) Pub. No.: US 2006/0044620 A1
(43) Pub. Date: Mar. 2, 2006

(54) Image processing device and image processing method

(75) Inventor: Hirofumi Namikawa, Kameoka-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/189,256

(22) Filed: Jul. 25, 2005

(30) Foreign Application Priority Data
Aug. 30, 2004 (JP) 2004-250077

(51) Int. Cl. H04N 1/23

(52) U.S. Cl. 358/296; 358/448

(57) ABSTRACT

An image processing device includes a CCD line sensor, a CIS scanning unit and an image processor. The CCD line sensor scans image data of a front side of an original document. The CIS scanning unit scans image data of a reverse side. The image processor carries out an image processing on the image data scanned by the CCD line sensor or the CIS scanning unit. The image processing unit extracts valid data from the image data of the front side or the reverse side and carries out a prescribed image processing.

### BACKGROUND OF THE INVENTION

1. Field of the Invention

The present invention relates to an image processing device, and more particularly to an image processing device which carries out an image processing on image data of a front side and image data of a reverse side of an original document, which both sides are scanned by two asynchronous scanning devices while being transported in one direction. For example, the present invention can be applied to various devices having an image processing device which scans image data of both sides of an original document by two asynchronous scanning devices while transporting the original document in one direction and carries out an image processing.

2. Description of Related Art

In a known device which scans image data of both sides of an original document by two scanning devices while transporting the original document in one direction along a transportation path, in other words, in a device which carries out a one-pass duplex scanning operation, in general, the image data of both sides of the original document are scanned by a Charge-Coupled Device (CCD) line sensor and a Contact Image Sensor (CIS), which are respectively disposed on a front side and a reverse side of the transportation path.

An image scanning device shown in FIG. 7 is a known device which carries out a duplex scanning operation of an original document by a CCD line sensor and a CIS. When the image scanning device shown in FIG. 7 carries out the duplex scanning operation of the original document, a first photoelectric transducer (CCD) 51, which scans image data of a front side (one of the sides) of the original document, scans the image data of the front side of the original document for each main scanning line in accordance with an operation clock generated by a first drive clock generator 52. A first counter 53 counts a number of operation clocks generated by the first drive clock generator 52. A first comparator 54 compares the number of the operation clocks counted by the first counter 53 and a preset first standard value. A scanning control unit 55 controls the first photoelectric transducer 51 to continuously scan the image data of the front side until a valid signal is input from the first comparator 54 when the counted number of the operation clocks and the first standard value match with one another.

Meanwhile, a second photoelectric transducer (CIS) 56, which scans image data of a reverse side (another side) of the original document, scans image data of the reverse side (the other side) of the original document for each main scanning line in accordance with an operation clock generated by a second drive clock generator 57. A second counter 58 counts a number of operation clocks generated by the second drive clock generator 57. A second comparator 59 compares the number of the operation clocks counted by the second counter 58 and a preset second standard value. The scanning control unit 55 controls the second photoelectric transducer 56 to continuously scan the image data of the reverse side until a valid signal is input from the second comparator 59 when the counted number of the operation clocks and the second standard value match with one another.

Suppose that T1 is a cycle of an operation clock generated by the first drive clock generator 52, T2 is a cycle of an operation clock generated by the second drive clock generator 57, C1 is a number of operation clocks counted by the first counter 53, and C2 is a number of operation clocks counted by the second counter 58. Then, by setting a value expressed by an equation T1*C1−T2*C2 to be a regulatory value or smaller, a difference between a scanning time of the first photoelectric transducer 51 and a scanning time of the second photoelectric transducer 56 can be reduced. That is, by previously setting the first standard value and the second standard value at an appropriate value so as to satisfy the above condition, the difference can be reduced.

However, in the above-described device in which the operation clock for controlling the CCD line sensor and the operation clock for controlling the CIS are asynchronous, when carrying out an image processing by the same image processor, there exists a drawback of deterioration of an image due to a displacement of a position of the image data input from each sensor to the image processor, in other words, a displacement of a position of the image data of the front side and the image data of the reverse side.

Specifically, a line start signal (a signal input per line so that a scanning operation is carried out by both the CCD line sensor and the CIS) is input under a prescribed cycle to the CCD line sensor and the CIS from the image processor. However, although the image data of the front side is input from the CCD line sensor to the image processor in synchronism with the line start signal, the image data of the reverse side is input from the CIS to the image processor under a different timing (asynchronously) as the line start signal. Accordingly, there exists a drawback of a deterioration of an image.

Another known device having a CIS scanning unit is specified to vary a position of image data of a reverse side (in a main scanning direction), in other words, an interval from when a line start signal is input to a CIS until when the image data of the reverse side is input from an image processor to the CIS, each time when a power of a device main body is turned on. In such a known device, there exists a drawback that with respect to the image data of the reverse side, a position of valid data, which is used actually in a subsequent image processing or a printing process, varies each time when a power is turned on.

### SUMMARY OF THE INVENTION

The present invention has been made in consideration of the above-described circumstances. An advantage of the present invention is to provide an image processing device which carries out an image processing on image data of both sides of an original document scanned by two asynchronous scanning devices while transporting the original document in one direction, and more particularly, an image processing device which can prevent a generation of a drawback such as a deterioration of an image due to image data of a front side and image data of a reverse side being input under different timings.

According to an aspect of the present invention, an image processing device includes a first scanning unit, a second scanning unit and an image processor. The first scanning unit scans image data of a front side of an original document. The second scanning unit scans image data of a reverse side of the original document. The image processor carries out an image processing on the image data scanned by the first scanning unit and the second scanning unit. The image processor includes an image processing unit, a generator, a first input unit and a second input unit. The image processing unit extracts valid data from the scanned image data of the front side or the reverse side and carries out a prescribed image processing. The generator generates a first line start signal as a standard of a scanning operation of the first scanning unit. The first input unit selectively inputs the first line start signal or a second line start signal to the image processing unit. The second line start signal is a signal as a standard of a scanning operation of the second scanning unit. The second input unit selectively inputs a first standard clock or a second standard clock to the image processing unit. The first standard clock is a clock as a standard of a processing in which the first scanning unit outputs the image data of the front side per pixel. The second standard clock is a clock as a standard of a processing in which the second scanning unit outputs image data of the reverse side per pixel. For the image data of the front side, the image processing unit counts a number of the first standard clock on a basis of the first line start signal and extracts the valid data. For the image data of the reverse side, the image processing unit counts a number of the second standard clock on a basis of the second line start signal and extracts the valid data.

According to another aspect of the present invention, the image processing device includes two image processors. In such a case, the first scanning unit is connected to one of the image processors, and the second scanning unit is connected to another one of the image processors. The one of the image processors carries out a processing on the image data of the front side scanned by the first scanning unit. The other one of the image processors carries out a processing on the image data of the reverse side scanned by the second scanning unit.

According to another aspect of the present invention, the image processor includes a register which stores switching information of the first input unit and the second input unit. The switching of the first input unit and the second input unit is carried out by rewriting the switching information of the register.

According to the above-described aspect of the present invention, the image processing device can control both of the scanning operation of the first scanning unit and the scanning operation of the second scanning unit. Moreover, the image processing on the image data of the front side scanned by the first scanning unit and the image processing on the image data of the reverse side scanned by the second scanning unit can be carried out by time sharing. That is, different scanning devices can be controlled by one image processor by time sharing. Therefore, the image processing device according to the present invention is advantageous in that an image processor, which carries out an image processing on the image data of the front side scanned by the first scanning unit, and an image processor, which carries out an image processing on the image data of the reverse side scanned by the second scanning unit, are not required to be provided individually.

A line start signal as a standard for extracting the valid data is switched when processing the image data of the front side scanned by the first scanning unit and when processing the image data of the reverse side scanned by the second scanning unit. Accordingly, even when an interval between the first line start signal and the second line start signal (an interval from when the first line start signal is input to the second scanning unit until when the image data of the reverse side is input from the image processor to the second scanning unit) varies, optimum valid data can be extracted from the image data of the front side or the image data of the reverse side. In other words, regardless of whether the image data is the image data of the front side of the original document or the image data of the reverse side of the original document, valid data can be extracted from the same position in the main scanning direction and a deterioration of an image can be prevented.

According to the above-described aspect of the present invention, when an image processor is provided respectively to the first scanning unit and the second scanning unit, the image processing on the image data of the front side scanned by the first scanning unit and the image processing on the image data of the reverse side scanned by the second scanning unit can be carried out concurrently. If both of the image processors have the same configuration, both of the image processors can control either one of the first scanning unit and the second scanning unit. Therefore, the image processing device of the present invention is advantageous in that a hardware configuration of the image processors connected to the first scanning unit and the second scanning unit are not required to be varied.

According to the above-described aspect of the present invention, the image processing device is advantageous in that the first input unit and the second input unit can be switched easily by rewriting the switching information of the register. For example, the first input unit and the second input unit can be switched per line (main scanning line). That is, the processing on the image data of the front side and the processing on the image data of the reverse side can be switched for each line (main scanning line) and carried out by the image processing unit.

### BRIEF DESCRIPTION OF THE DRAWINGS

FIG. 1 is a block diagram showing an example of a configuration of an image processing device according to a first embodiment of the present invention.

FIG. 2 schematically shows a configuration around a transportation path of an Automatic Document Feeder (ADF) of a document scanning unit.

FIG. 3 shows a specific configuration of a document scanning unit and an image processor.

FIG. 4 illustrates valid data and invalid data of scanned image data of an original document.

FIG. 5 shows an example of valid data relating to image data of a front side and valid data relating to image data of a reverse side of an original document output from a valid data extracting circuit to an image processing circuit when an SH signal and an LST signal are input to the valid data extracting circuit.

FIG. 6 shows a specific configuration of a document scanning unit and an image processor of an image processing device according to a second embodiment of the present invention.

FIG. 7 shows a configuration of a scanning unit of a conventional image scanning device.

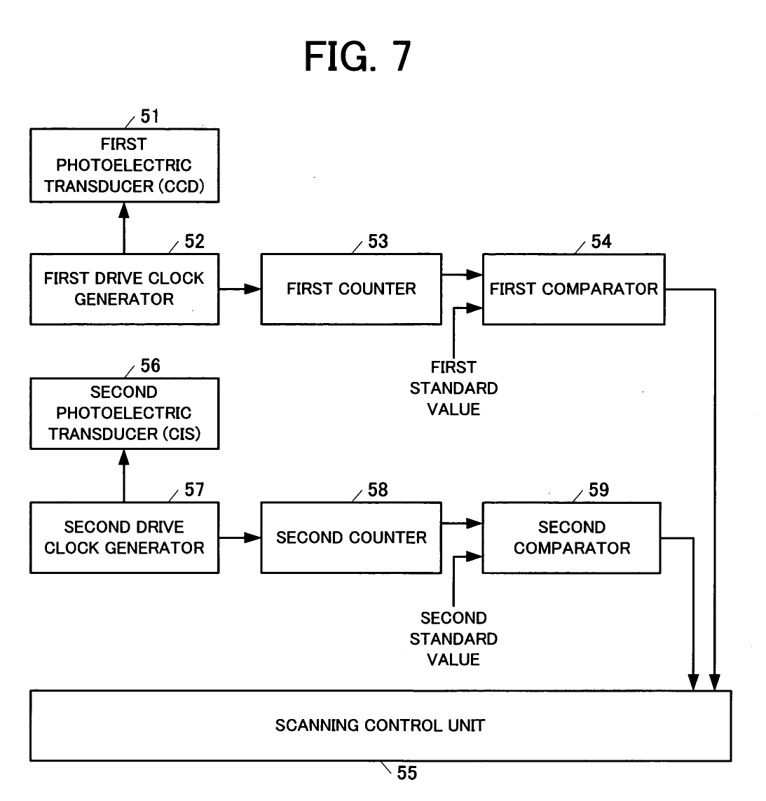

### DETAILED DESCRIPTION OF THE INVENTION

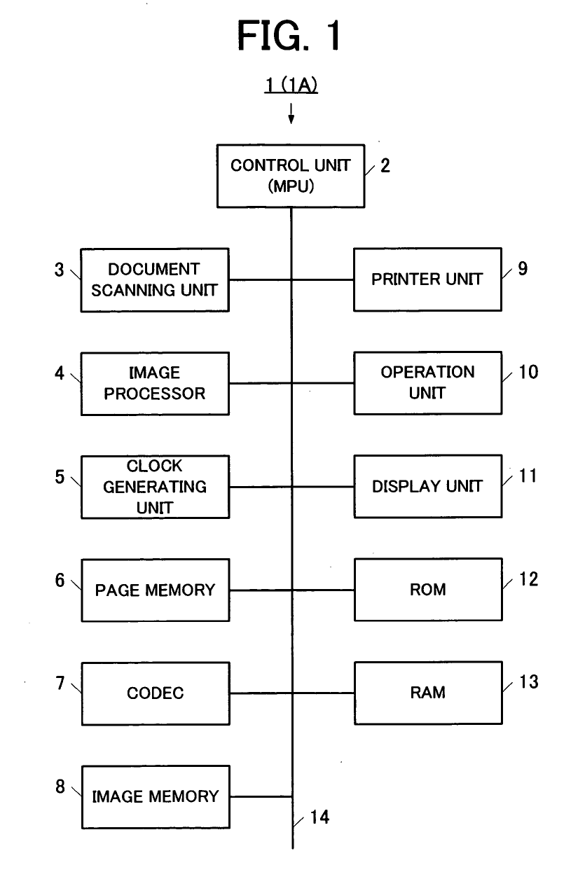

With reference to the drawings, an image processing device will be described according to a first embodiment of the present invention. FIG. 1 is a block diagram showing an example of a configuration of an image processing device according to a first embodiment of the present invention. As shown in the drawing, an image processing device 1 includes a control unit (Micro Processing Unit (MPU)) 2, a document scanning unit 3, an image processor 4, a clock generating unit 5, a page memory 6, a coder and decoder (CODEC) 7, an image memory 8, a printer unit 9, an operation unit 10, a display unit 11, a Read Only Memory (ROM) 12 and a Random Access Memory (RAM) 13. Each of the units 2 through 13 is connected via a bus 14 in a manner that communication can be carried out.

The control unit 2 controls an operation of each of the units of the image processing device 1. The document scanning unit 3 includes a function for scanning image data of both sides of an original document while transporting the original document in one direction, that is, a function for carrying out a one-pass duplex scanning operation. Although not shown in the drawing, the document scanning unit 3 includes an ADF and a Flat Bed Scanner (FBS) or the like. The ADF transports an original document placed on a document tray. The FBS scans image data of an original document placed on a transparent document placing table or image data of an original document transported by the ADF.

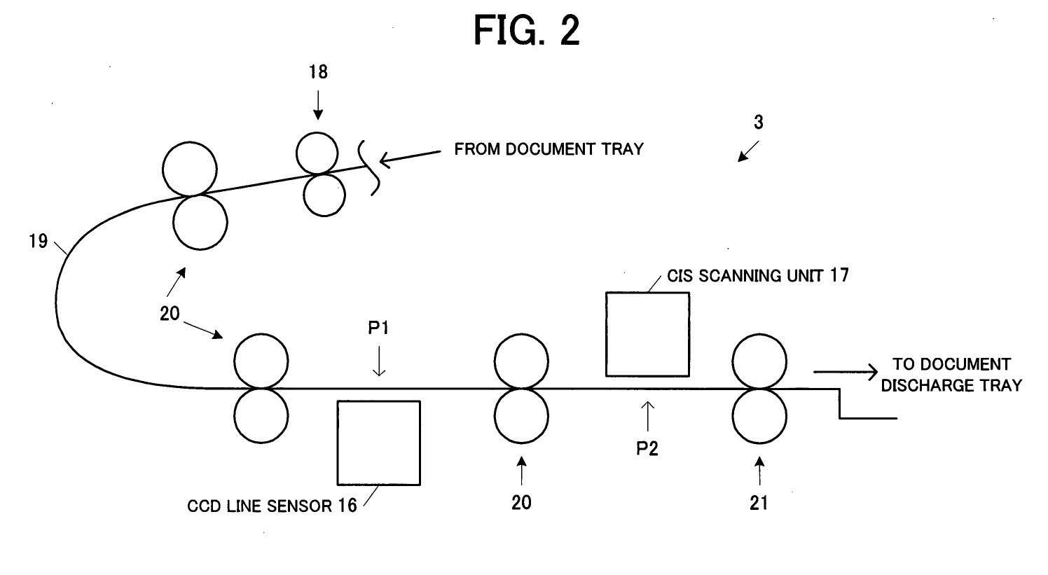

FIG. 2 schematically shows a configuration around a transportation path of the ADF of the document scanning unit 3. The FBS (not shown) includes a CCD line sensor 16 for scanning image data of a front side (one of the sides) of an original document. The ADF includes a CIS scanning unit 17 for scanning image data of a reverse side (another side) of the original document. The CCD line sensor 16 and the CIS scanning unit 17 enable the above-mentioned one-pass duplex scanning operation.

The CCD line sensor 16 is a charge-coupled device for scanning the image data of the front side of the original document for each main scanning line. Further, although not shown in the drawing, the FBS includes a light source for irradiating light on an original document, a reflecting mirror for guiding reflected light from the original document towards a prescribed direction, and a light-gathering lens for focusing the reflected light, or the like. The CCD line sensor 16 converts focused light focused by the light-gathering lens into an electric signal and outputs the electric signal. The CCD line sensor 16 functions as a first scanning unit for scanning the image data of the front side of the original document. The CCD line sensor 16 scans the image data of the front side of the original document, which is transported in one direction by the ADF.

The CIS scanning unit 17 uses a CIS, and although not shown in the drawing, is a fixed-type scanning unit for scanning the original document by focusing the reflected light from the original document, which is irradiated by the light source, onto a photoconductive element by a focusing fiber. Further, the CIS scanning unit 17 includes an Analog-to-Digital (A/D) converter. After the image data of the reverse side of the original document is scanned by the CIS scanning unit 17, an A/D conversion is carried out on the scanned image data of the reverse side. Then, the A/D converted image data (multi-value data) is output from the CIS scanning unit 17. The CIS scanning unit 17 functions as a second scanning unit for scanning the image data of the reverse side of the original document. The CIS scanning unit 17 scans the image data of the reverse side of the original document, which is transported in one direction by the ADF.

When scanning both sides of an original document by the document scanning unit 3, an original document placed on a document tray is fed into a transportation path 19 by paper feed rollers 18. The original document fed into the transportation path 19 is transported by transportation rollers 20, reversed so as to make a U-turn from an upper part to a lower part, and led to a scanning position P1. Further, a light-transmittance plate (not shown) is provided on the scanning position P1. When the original document passes the scanning position P1, the image data of the front side is scanned by the CCD line sensor 16. Then, the original document is transported further along the transportation path 19. When the original document passes a scanning position P2, the image data of the reverse side is scanned by the CIS scanning unit 17. As described above, after both sides of the original document are scanned by the CCD line sensor 16 and the CIS scanning unit 17, the original document is discharged onto a document discharge tray located below the document tray by discharge rollers 21. Further, when the one-pass duplex scanning operation of the original document is carried out as described above, there exists a period of time when the scanning operation is carried out simultaneously by the CCD line sensor 16 and the CIS scanning unit 17. Therefore, a duplex scanning operation is carried out on the original document transported at a uniform transportation speed. In other words, the duplex scanning operation of the original document is carried out at a uniform scanning speed.

Further, the CCD line sensor 16 (the first scanning unit) and the CIS scanning unit 17 (the second scanning unit) have different capabilities regarding the scanning speed. That is, a light-accumulating time of the CCD line sensor 16 is shorter than a light-accumulating time of the CIS of the CIS scanning unit 17. Therefore, a maximum scanning speed at which the CCD line sensor 16 is capable of scanning independently is higher than a maximum scanning speed at which the CIS scanning unit 17 is capable of scanning independently. In consideration of such a difference in the maximum scanning speeds, the duplex scanning operation of the original document is carried out at a speed slower than the maximum scanning speed at which the CCD line sensor 16 is capable of scanning independently, in other words, at a capable scanning speed of the CIS scanning unit 17. In the first embodiment, a description will be made of an example in which the image data of both sides of the original document is scanned by the CCD line sensor 16 and the CIS scanning unit 17. However, image data of a single side of the original document can be scanned by using only the CCD line sensor 16.

The image processor 4 shown in FIG. 1 carries out an image processing on the image data of the original document (the image data of the front side and the image data of the reverse side) scanned by the document scanning unit 3. That is, the image processor 4 carries out an image processing on the image data (the image data of the front side and the image data of the reverse side) scanned by the CCD line sensor 16 and the CIS scanning unit 17. The clock generating unit 5 generates a first standard clock and an external clock. The first standard clock is a standard for a scanning operation of the CCD line sensor 16 of the document scanning unit 3 and an operation of the entire image processor 4. The external clock is generated for driving the CIS scanning unit 17 of the document scanning unit 3. Further, a cycle of the first standard clock and a cycle of the external clock are determined according to the scanning speed of the original document of the document scanning unit 3, respectively.

The page memory 6 is a memory for storing the image data (the image data of the front side and the image data of the reverse side) of the original document processed by the image processor 4. The CODEC 7 encodes and decodes the image data. The CODEC 7 encodes the image data of the original document, which is processed by the image processor 4 and stored in the page memory 6, by the Modified Huffman (MH), the Modified Read (MR), the Modified Modified Read (MMR), the Joint Bi-level Image Group (JBIG) scheme or the like. The CODEC 7 also decodes encoded image data.

For example, the image memory 8 stores the image data encoded by the CODEC 7 and the image data output directly from the page memory 6. The printer unit 9 prints an image of the image data retrieved from the image memory 8 onto paper. As a printing method of the printer unit 9, for example, various printing methods such as an electro-photographic method and an inkjet printing method can be adopted.

Although not shown in the drawing, the operation unit 10 includes various operation keys operating in synchronism with the display unit 11. For example, the various operation keys includes a start key for instructing a start of the scanning operation or the like of the original document to the document scanning unit 3, and a ten-key numeric pad for entering a number of sets of copies or the like. A user carries out various operations from the operation unit 10. The display unit 11 includes a Liquid Crystal Display (LCD) and a Light Emitting Diode (LED) lamp or the like for displaying various setting screens and an operation status of the image processing device 1 or the like. The LCD carries out the display with a character and a figure or the like, and the LED lamp carries out the display by being lighted or turned off. Further, the LCD may be formed of a touch screen, and instead of operating the operation unit 10, various operations can be performed from the display unit 11.

The ROM 12 stores various programs for controlling a processing operation of each of the units of the image processing device 1 by the control unit 2. The processing operation of each of the units of the image processing unit 1 is carried out by following a command generated by the control unit 2 in accordance with various control programs stored in the ROM 12. The RAM 13 retrieves various data, such as setting information and operation information, to be used in the processing operation of the image processing device 1. The RAM 13 stores the retrieved data under a writable form.

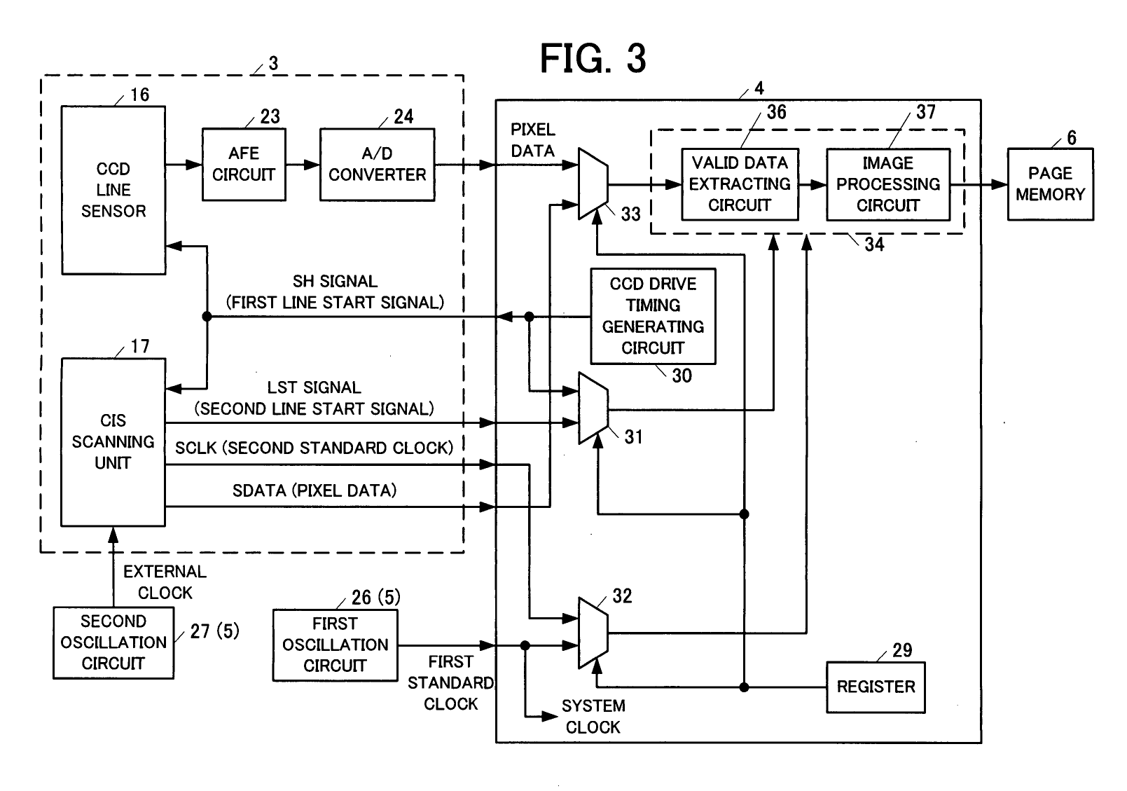

FIG. 3 shows a specific configuration of the document scanning unit 3 and the image processor 4. The document scanning unit 3 includes the CCD line sensor 16, an Analog Front End (AFE) circuit 23, an A/D converter 24 and the CIS scanning unit 17.

The AFE circuit 23 carries out a gain-adjustment on the image data of the original document (the image data of the front side) scanned by the CCD line sensor 16, in accordance with a preset gain set value. The A/D converter 24 carries out an A/D conversion on the image data of the front side, which is gain-adjusted by the AFE circuit 23. Pixel data, which constitutes the image data of the front side executed with the A/D conversion by the A/D converter 24, is input to the image processor 4. Further, the CIS scanning unit 17 carries out an A/D conversion on each pixel data (“SDATA” in the drawing), which constitutes the image data of the reverse side scanned by the CIS scanning unit 17. Then, the pixel data is input directly to the image processor 4.

A first oscillation circuit 26 (5) and a second oscillation circuit 27 (5) of the clock generating unit 5 are respectively an oscillation circuit having a crystal oscillator and an inverter. A clock generated by the first oscillation circuit 26 (a first standard clock) is input to the image processor 4. The first standard clock input to the image processor 4 is used as a standard of a processing of the entire image processor 4 (hereinafter referred to as a “system clock”). Further, although not shown in the drawing, the first standard clock generated by the first oscillation circuit 26 is input also to the CCD line sensor 16, the AFE circuit 23 and the A/D converter 24. Each of the CCD line sensor 16, the AFE circuit 23 and the A/D converter 24 operates in synchronism with the input first standard clock. The above-mentioned system clock differs from a system clock of the control unit 2. A clock generated by the second oscillation circuit 27 (5) (an external clock) is input to the CIS scanning unit 17.

The image processor 4, which carries out an image processing on the image data scanned by the CCD line sensor 16 and the CIS scanning unit 17, includes a register 29, a CCD drive timing generating circuit 30, a first selector 31, a second selector 32, a third selector 33 and an image processing unit 34.

The register 29 of the image processor 4 is formed of a flip-flop, and stores switching information of the first selector 31, the second selector 32 and the third selector 33. The switching information is information for switching a connection between the CCD line sensor 16 and the image processing unit 34 and a connection between the CIS scanning unit 17 and the image processing unit 34. Although detail will be described later, the first selector 31, the second selector 32 and the third selector 33 are switched by the switching information of the register 29 being rewritten by the control unit 2 or the like. Specifically, the switching information stored in the register 29 is either one of information indicating to connect the CCD line sensor 16 and the image processing unit 34 (hereinafter referred to as “switching information 1”) and information indicating to connect the CIS scanning unit 17 and the image processing unit 34 (hereinafter referred to as “switching information 2”).

The CCD drive timing generating circuit 30 functions to generate a first line start signal as a standard of the scanning operation of the CCD line sensor 16 (first scanning unit). Specifically, the CCD drive timing generating circuit 30 generates the first line start signal (hereinafter also referred to as an “SH signal”) in accordance with the first standard clock generated by the first oscillation circuit 26. The SH signal generated by the CCD drive timing generating circuit 30 is input to the CCD line sensor 16 and the CIS scanning unit 17. The CCD line sensor 16 scans the image data of the front side of the original document for each main scanning line in synchronism with the SH signal. That is, the CCD line sensor 16 scans image data of one line (main scanning line) of the front side of the original document each time when the SH signal is input. Meanwhile, the CIS scanning unit 17 carries out a sampling of the input SH signal by the external clock input from the second oscillation circuit 27, and generates a second line start signal (hereinafter also referred to as a “LST signal”). The CIS scanning unit 17 scans the image data of the reverse side of the original document in synchronism with the generated LST signal. That is, the CIS scanning unit 17 scans the image data of the reverse side of the original document for each one line (main scanning line) in accordance with the LST signal generated by the CIS scanning unit 17. Therefore, the first line start signal (SH signal), which is the line start signal of the CCD line sensor 16, and the second line start signal (LST signal), which is the line start signal of the CIS scanning unit 17, are asynchronous. That is, the CCD line sensor 16 and the CIS scanning unit 17 carry out the scanning operation of the original document under different timings. Further, the SH signal of the CCD line sensor 16 generated by the CCD drive timing generating circuit 30 and the LST signal of the CIS scanning unit 17 generated by the CIS scanning unit 17 are input to the first selector 31 of the image processor 4.

The first selector 31 functions as a first input unit for selectively inputting the SH signal (the first line start signal) or the LST signal (the second line start signal) to the image processing unit 34 (the image processing unit). Further, the SH signal is generated by the CCD drive timing generating circuit 30. The LST signal is a standard of the scanning operation of the CIS scanning unit 17 (a second scanning unit). The SH signal and the LST signal are asynchronous. The first selector 31 switches a connection between the CCD drive timing generating circuit 30 and the image processing unit 34 and a connection between the CIS scanning unit 17 and the image processing unit 34, in accordance with the switching information of the register 29. Specifically, under a state in which the register 29 stores the switching information 1, when the CIS scanning unit 17 and the image processing unit 34 are connected, the first selector 31 switches the connection to connect the CCD drive timing generating circuit 30 and the image processing unit 34. Further, after the connection is switched, the SH signal generated by the CCD drive timing generating circuit 30 is input to the image processing unit 34 via the first selector 31.

Meanwhile, under a state in which the register 29 stores the switching information 2, when the CCD drive timing generating circuit 30 and the image processing unit 34 are connected, the first selector 31 switches the connection to connect the CIS scanning unit 17 and the image processing unit 34. Further, after the connection is switched, the LST signal generated by the CIS scanning unit 17 is input to the image processing unit 34 via the first selector 31.

The second selector 32 functions as a second input unit for selectively inputting the first standard clock or the second standard clock (“SCLK” in the drawing) to the image processing unit 34. Further, the first standard clock is a standard of the processing in which the CCD line sensor 16 outputs the image data of the front side per pixel and the processing of the entire image processor 4. The second standard clock is a standard of the processing in which the CIS scanning unit 17 outputs the image data of the reverse side per pixel. The second selector 32 switches a connection between the first oscillation circuit 26 and the image processing unit 34 and a connection between the CIS scanning unit 17 and the image processing unit 34. Specifically, under a state in which the register 29 stores the switching information 1, when the CIS scanning unit 17 and the image processing unit 34 are connected, the second selector 32 switches the connection to connect the first oscillation circuit 26 and the image processing unit 34. Further, after the connection is switched, the first standard clock generated by the first oscillation circuit 26 is input to the image processing unit 34 via the second selector 32.

Meanwhile, under a state in which the register 29 stores the switching information 2, when the first oscillation circuit 26 and the image processing unit 34 are connected, the second selector 32 switches the connection to connect the CIS scanning unit 17 and the image processing unit 34. Further, after the connection is switched, the SCLK generated by the CIS scanning unit 17 is input to the image processing unit 34 via the second selector 32. The SCLK is a clock per pixel. The SDATA, which constitutes the image data of the reverse side scanned by the CIS scanning unit 17, is input to the third selector 33 of the image processor 4 in synchronism with the SCLK. Each pixel data constituting the image data of the front side, which is scanned by the CCD line sensor 16 and executed with the gain-adjustment by the AFE circuit 23 and the A/D conversion by the A/D converter 24, is input to the third selector 33 of the image processor 4 in synchronism with the first standard clock (system clock).

The third selector 33 switches a connection between the A/D converter 24 and the image processing unit 34 and a connection between the CIS scanning unit 17 and the image processing unit 34, in accordance with the switching information of the register 29. Specifically, under a state in which the register 29 stores the switching information 1, when the CIS scanning unit 17 and the image processing unit 34 are connected, the third selector 33 switches the connection to connect the A/D converter 24 and the image processing unit 34. Further, after the connection is switched, each pixel data constituting the image data of the front side, which is scanned by the CCD line sensor 16 and executed with the gain-adjustment by the AFE circuit 23 and the A/D conversion by the A/D converter 24, is input to the image processing unit 34 via the third selector 33 in synchronism with the first standard clock.

Under a state in which the register 29 stores the switching information 2, when the A/D converter 24 and the image processing unit 34 are connected, the third selector 33 switches the connection to connect the CIS scanning unit 17 and the image processing unit 34. Further, after the connection is switched, each pixel data (SDATA), which constitutes the image data of the reverse side output from the CIS scanning unit 17, is input to the image processing unit 34 via the third selector 33 in synchronism with the SCLK.

The image processing unit 34 functions as an image processing unit for extracting valid data from the image data of the front side or the image data of the reverse side scanned by the CCD line sensor 16 and the CIS scanning unit 17 and carrying out a prescribed image processing. The image processing unit 34 includes a valid data extracting circuit 36 and an image processing circuit 37. The valid data extracting circuit 36 deletes pixel data of a prescribed number of pixels at both ends of the original document in a main scanning direction from the image data of the front side input from the A/D converter 24 or the image data of the reverse side input from the CIS scanning unit 17. Then, the valid data extracting circuit 36 extracts remaining pixel data (hereinafter referred to as “valid data”). The valid data extracted by the valid data extracting circuit 36 is output to the image processing circuit 37.

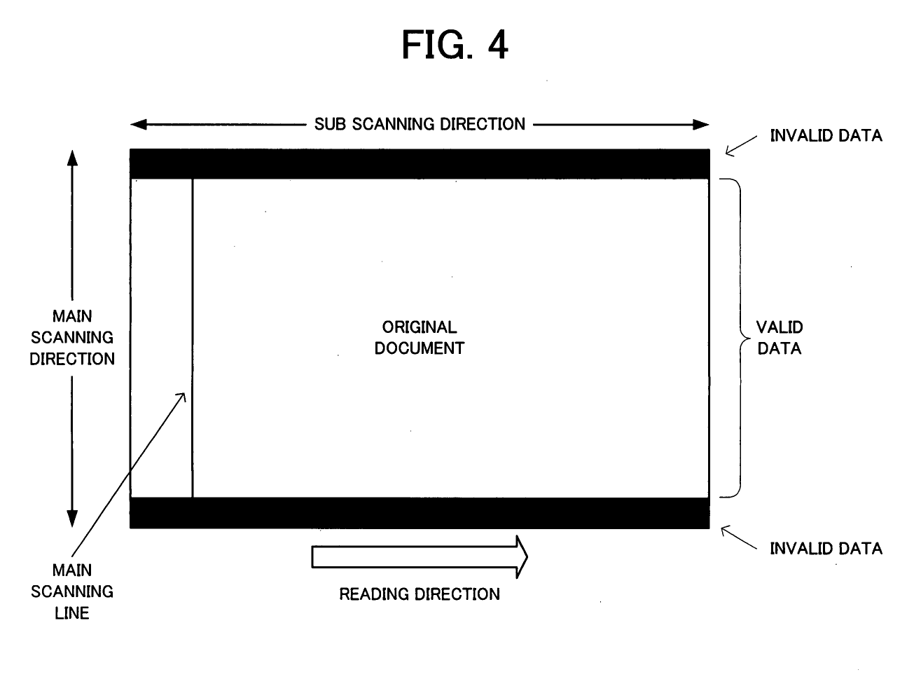

FIG. 4 illustrates valid data and invalid data relating to the scanned image data of the original document. As shown in the drawing, when the duplex scanning operation of the original document is carried out by the CCD line sensor 16 and the CIS scanning unit 17, while each main scanning line of the CCD line sensor 16 and the CIS scanning unit 17 is moving relatively in a reading direction in the drawing with respect to the original document, the image data of both sides of the original document is scanned for each main scanning line. In this case, since both end parts of the original document in the main scanning direction are boundary parts between an original document area and outside the original document area, there exists image data which should not be executed with a subsequent image processing and printing process onto paper (hereinafter referred to as “invalid data”). Therefore, the valid data extracting circuit 36 destroys the invalid data of a prescribed number of pixels at both ends in the main scanning direction from the pixel data of the image data of the front side input from the CCD line sensor 16 and the pixel data of the image data of the reverse side input from the CIS scanning unit 17 by being scanned for each line (main scanning line). Then, the valid data extracting circuit 36 extracts the valid data between the invalid data. The extracted valid data is input to the image processing circuit 37.

The image processing circuit 37 carries out an image processing on the valid data extracted by the valid data extracting circuit 36. Specifically, the image processing circuit 37 carries out an image processing such as a shading correction and a y correction on the valid data input from the valid data extracting circuit 36. The shading correction corrects unevenness of light intensity, an influence of an optical component, and unevenness of pixel sensitivity of the CCD line sensor 16 and the CIS of the CIS scanning unit 17.

With reference to FIG. 1 through FIG. 5, a description will be made of a processing operation of each component of the document scanning unit 3 and the image processor 4 when the duplex scanning operation of the original document is carried out in the image processing device 1 according to the first embodiment of the present invention. When an instruction for carrying out the duplex scanning operation of the original document is input from the operation unit 10, an original document placed on the document tray of the ADF is transported along the transportation path 19. The first oscillation circuit 26 generates the first standard clock, and the second oscillation circuit 27 generates the external clock. The first standard clock generated by the first oscillation circuit 26 is input as a system clock to the image processor 4 and input to the second selector 32 of the image processor 4. The external clock generated by the second oscillation circuit 27 is input to the CIS scanning unit 17.

The CCD drive timing generating circuit. 30 of the image processor 4 generates the SH signal of a prescribed cycle in accordance with the system clock input from the first oscillation circuit 26. The SH signal generated by the CCD drive timing generating circuit 30 is input to the CCD line sensor 16 and the CIS scanning unit 17. Meanwhile, the CCD line sensor 16 scans the image data of the front side of the original document per one line for each main scanning line in accordance with (in synchronism with) the input SH signal. Each pixel data of the image data of the front side scanned by the CCD line sensor 16 is executed with a gain-adjustment by the AFE circuit 23 and then executed with an A/D conversion by the A/D converter 24.

Meanwhile, the CIS scanning unit 17 carries out a sampling of the SH signal input from the CCD drive timing generating circuit 30 by the external clock input from the second oscillation circuit 27, and generates the LST signal. Then, in accordance with (in synchronism with) the generated LST signal, the CIS scanning unit 17 scans the image data of the reverse side of the original document per one line for each main scanning line.

In the image processor 4, when the register 29 stores the switching information 1, the SH signal is input from the CCD drive timing generating circuit 30 via the first selector 31 to the image processing unit 34, the first standard clock is input from the first oscillation circuit 26 via the second selector 32 to the image processing unit 34, and the pixel data of the image data of the front side is input from the A/D converter 24 via the third selector 33 to the image processing unit 34.

Meanwhile, the valid data extracting circuit 36 of the image processing unit 34 extracts valid data (pixel data) from the image data of the front side input from the A/D converter 24. Specifically, on a basis of the SH signal input from the CCD drive timing generating circuit 30 via the first selector 31, the valid data extracting circuit 36 counts a number of the first standard clock input from the first oscillation circuit 26 via the second selector 32. Until the counted number of the first standard clock reaches a preset value, the valid data extracting circuit 36 destroys the pixel data input from the AID converter 24 via the third selector 33 as the invalid data. After the counted number of the first standard clock reaches the preset value, the valid data extracting circuit 36 extracts the pixel data input from the A/D converter 24 via the third selector 33 as the valid data, and outputs the extracted valid data to the image processing circuit 37. Next, after the counted number of the first standard clock reaches another preset value, the valid data extracting circuit 36 destroys the pixel data input from the A/D converter 24 via the third selector 33 as the invalid data.

The series of processes are carried out repeatedly each time when the SH signal is input from the CCD drive timing generating circuit 30. That is, the processes are carried out repeatedly for each pixel data of one line in the main scanning direction which constitutes the image data of the front side input from the A/D converter 24. The image processing circuit 37 carries out a necessary image processing, such as the shading correction and the y correction, on the valid data of the image data of the front side input from the valid data extracting circuit 36. The image data of the front side executed with the image processing as described above is stored in the page memory 6.

In the image processor 4, when the register 29 stores the switching information 2, the LST signal is input from the CIS scanning unit 17 via the first selector 31 to the image processing unit 34, the SCLK is input from the CIS scanning unit 17 via the second selector 32 to the image processing unit 34, and the pixel data (SDATA) of the image data of the reverse side is input from the CIS scanning unit 17 via the third selector 33 to the image processing unit 34.

Meanwhile, the valid data extracting circuit 36 of the image processing unit 34 extracts the valid data (pixel data) from the image data of the reverse side input from the CIS scanning unit 17. Specifically, on a basis of the LST signal input from the CIS scanning unit 17 via the first selector 31, the valid data extracting circuit 36 counts a number of SCLK input from the CIS scanning unit 17 via the second selector 32. Until the counted number of the SCLK reaches a preset value, the valid data extracting circuit 36 destroys the pixel data (SDATA) input from the CIS scanning unit 17 via the third selector 33 as the invalid data. After the counted number of the SCLK reaches the preset value, the valid data extracting circuit 36 extracts the pixel data input from the CIS scanning unit 17 via the third selector 33 as the valid data, and outputs the extracted valid data to the image processing circuit 37. Next, after the counted number of the SCLK reaches another preset value, the valid data extracting circuit 36 destroys the pixel data input from the CIS scanning unit 17 via the third selector 33 as the invalid data.

The series of processes are carried out repeatedly each time when the LST signal is input from the CIS scanning unit 17. That is, the processes are carried out repeatedly for each pixel data of one line in the main scanning direction which constitutes the image data of the reverse side input from the CIS scanning unit 17. The image processing circuit 37 carries out a necessary image processing, such as the shading correction and the y correction, on the valid data of the image data of the reverse side input from the valid data extracting circuit 36. The image data of the reverse side executed with the image processing as described above is stored in the page memory 6 along with the image data of the front side.

As described above, the image processing unit 34 (the valid data extracting circuit 36) extracts the valid data from the image data of the front side by counting the number of the first standard clock on the basis of the SH signal, and extracts the valid data from the image data of the reverse side by counting the number of the SCLK on the basis of the LST signal.

Further, in the duplex scanning operation of the original document, the scanning operation by the CCD line sensor 16 and the scanning operation by the CIS scanning unit 17 are carried out concurrently. Therefore, for example, the switching information of the register 29 is rewritten per line, and the selectors 31 through 33 are switched in accordance with the rewritten switching information. Then, in the image processing unit 34, the processing, which extracts the valid data from the image data of the front side and carries out a necessary image processing, and the processing, which extracts the valid data from the image data of the reverse side and carries out a necessary image processing, are carried out by time sharing.

As described above, the image processor 4 of the image processing device 1 can carry out a processing by switching the connection between the CCD line sensor 16 and the image processing unit 34 and the connection between the CIS scanning unit 17 and the image processing unit 34. That is, different scanning devices can be controlled by one image processor 4 by time sharing.

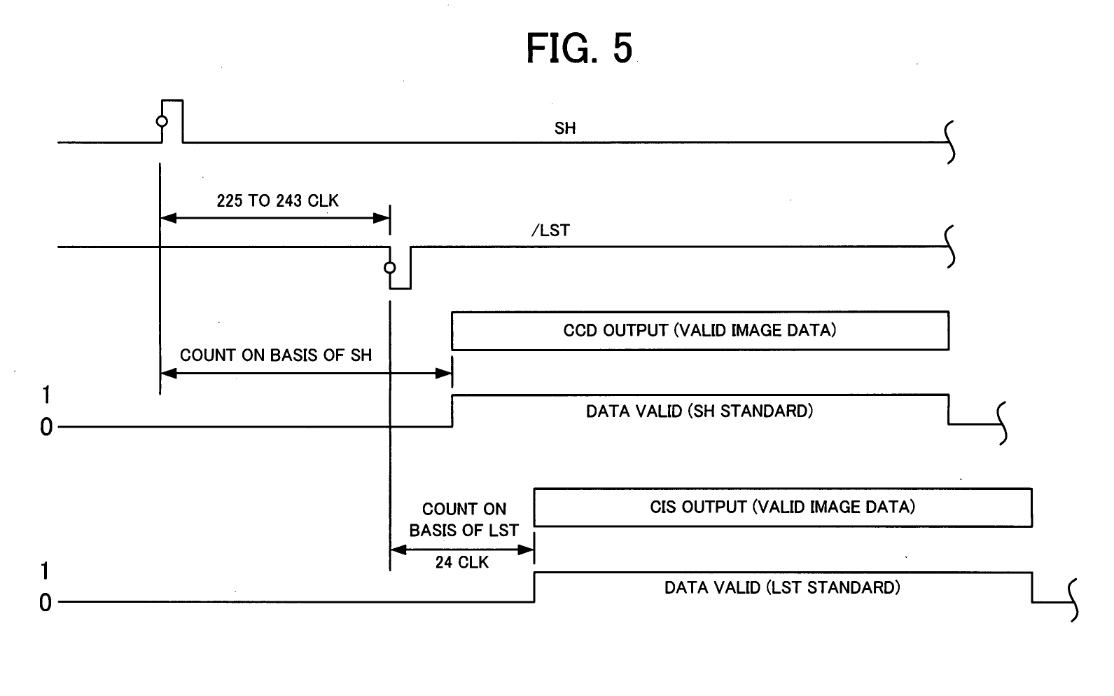

FIG. 5 shows an example of valid data of the image data of the front side and valid data of the image data of the reverse side output from the valid data extracting circuit 36 to the image processing circuit 37 when the SH signal and the LST signal are input to the valid data extracting circuit 36. The SH signal, which is the line start signal of the CCD line sensor 16, and the LST signal, which is the line start signal of the CIS scanning unit 17, are asynchronous. Therefore, as shown in the drawing, there exists a gap between the SH signal and the LST signal. In the first embodiment, due to specifications of the CIS scanning unit 17, the gap varies between 225 CLK and 243 CLK each time when the image processing device 1 is turned on.

If the gap is constant at all times, by counting the number of the SCLK, which is the number of the SDATA, on the basis of the SH signal, appropriate valid data can be extracted from the image data of the reverse side of the original document on the basis of the same line start signal (SH signal) as the CCD line sensor 16. However, since the gap between the SH signal and the LST signal varies as described above, if the number of the SCLK is counted on the basis of the SH signal and the valid data is extracted from the image data of the reverse side, the position of the extracted valid data varies each time when the image processing device 1 is turned on.

In the image processing device 1 according to the first embodiment of the present invention, as described above, even when the gap between the SH signal and the LST signal varies each time when the power is turned on, optimum valid data can be obtained by switching the standard (SH signal) for extracting the valid data from the image data of the front side and the standard (LST signal) for extracting the valid data from the image data of the reverse side by the first selector 31. That is, as shown in FIG. 5, the number of the pixel data (the number of the SCLK), which is counted as the invalid data from the image data of the reverse side by the valid data extracting circuit 36, is fixed at a value, for example, 24 pixels (CLK). The valid data extracting circuit 36 counts the number of the SCLK (the number of the pixel data) input via the second selector 32 on the basis of the LST signal input from the CIS scanning unit 17 via the first selector 31. Until the counted number of the SCLK reaches 24, the valid data extracting circuit 36 destroys the SDATA (pixel data) input via the third selector 33 as the invalid data. Then, after the counted number of the SCLK reaches 24 pixels, the valid data extracting circuit 36 extracts the SDATA input from the CIS scanning unit 17 via the third selector 33 as the valid data. Next, after extracting the valid data as described above, the valid data extracting circuit 36 also counts and destroys invalid data located on the opposite side in the main scanning direction of the original document with respect to the invalid data destroyed previously. Therefore, the valid data can be extracted from the same position at all times with respect to the image data of the reverse side. For the image data of both sides of the original document, a position of the pixel data to be executed with the image processing can be defined optimally.

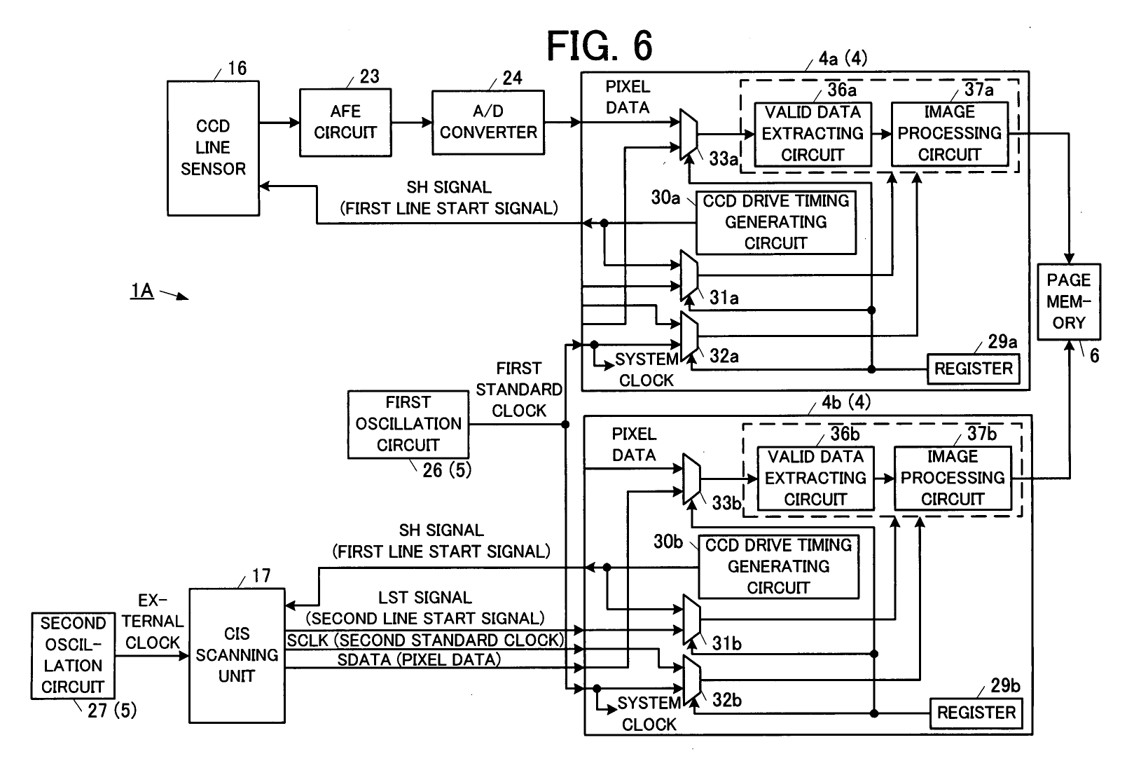

FIG. 6 shows a configuration of the document scanning unit 3 and the image processor 4 of an image processing device 1A according to another embodiment (second embodiment) of the image processing device 1 of the first embodiment. The image processing device 1A includes two image processors 4 described in the first embodiment. The CCD line sensor 16 (first scanning unit) is connected to one image processor 4a (4). The CIS scanning unit 17 (second scanning unit) is connected to another image processor 4b (4). The image processor 4a carries out a processing on the image data of the front side scanned by the CCD line sensor 16. The other image processor 4b carries out a processing on the image data of the reverse side scanned by the CIS scanning unit 17.

The image processing device 1A of the second embodiment has the same configuration as the image processing device 1 of the first embodiment excluding a fact that the image processing device 1A includes two image processors 4. Therefore, for the same configuration, the same reference numeral is applied and the description will be omitted. A description will be made primarily of difference. The configuration of each part of the image processor 4a and the image processor 4b is the same as each part of the image processor 4. To distinguish each part of the image processor 4a and each part of the image processor 4b, a reference numeral (a) is applied to each part of the image processor 4a, and a reference numeral (b) is applied to each part of the image processor 4b.

As shown in the drawing, the CCD line sensor 16 is connected to a third selector 33a of the image processor 4a via the AFE circuit 23 and the A/D converter 24. The CCD line sensor 16 is also connected to a CCD drive timing generating circuit 30a. Meanwhile, the CIS scanning unit 17 is connected to a first selector 31b, a second selector 32b and a third selector 33b of the image processor 4b.

In the image processing device 1 of the first embodiment, the SH signal is input to both of the CCD line sensor 16 and the CIS scanning unit 17 from the image processor 4. In the second embodiment, since two image processors 4 are provided, the SH signal is input from the image processor 4a to the CCD line sensor 16, and the SH signal is input from the other image processor 4b to the CIS scanning unit 17. The first oscillation circuit 26 is connected to both of the image processor 4a and the image processors 4b. In the CCD drive timing generating circuit 30a and the CCD drive timing generating circuit 30b, the same SH signal is generated in accordance with a system clock input from the first oscillation circuit 26, respectively. Both an image processing circuit 37a of the image processor 4a and an image processing circuit 37b of the image processor 4b are connected to the page memory 6.

When the duplex scanning operation of the original document is carried out in the image processing device 1A, in the image processor 4a, the CCD drive timing generating circuit 30a generates the SH signal in accordance with the system clock generated by the first oscillation circuit 26, and the generated SH signal is input to the CCD line sensor 16. The CCD line sensor 16 scans the image data of the front side of the original document for each main scanning line in accordance with the input SH signal. The scanned image data of the front side is executed with a gain-adjustment by the AFE circuit 23 and then executed with an A/D conversion by the A/D converter 24. Each pixel data of the image data of the front side, which is executed with the A/D conversion by the A/D converter 24, is input to the image processing unit 34a via the third selector 33a. Then, a valid data extracting circuit 36a executes a processing for extracting valid data, and the image processing circuit 37a executes an image processing such as a shading correction and a γ correction. The processed valid data is stored into the page memory 6. In the second embodiment, the SH signal generated by the CCD drive timing generating circuit 30a is input to the image processing unit 34a via the first selector 31a, and the first standard clock generated by the first oscillation circuit 26 is input to the image processing unit 34a via the second selector 32a.

The processing carried out by the valid data extracting circuit 36a and the image processing circuit 37a is the same as the processing carried out on the image data of the front side by the valid data extracting circuit 36 and the image processing circuit 37 described above. Therefore, a detailed description will be omitted. In the second embodiment, the image processor 4a carries out a processing only on the image data of the front side scanned by the CCD line sensor 16. Therefore, a register 29a stores the switching information 1 at all times, and the first selector 31a through the third selector 33a are not switched.

Meanwhile, in the image processor 4b, a CCD drive timing generating circuit 30b generates the SH signal in accordance with the system clock generated by the first oscillation circuit 26, and the generated SH signal is input to the CIS scanning unit 17. The CIS scanning unit 17 carries out a sampling on the input SH signal, and scans the image data of the reverse side of the original document for each main scanning line in accordance with the generated LST signal. Each pixel data (SDATA) of the scanned image data of the reverse side is input to the image processing unit 34b via the third selector 33b. Then, a valid data extracting circuit 36b extracts valid data, and the image processing circuit 37b carries out an image processing such as a shading correction and a γ correction. The processed valid data is stored into the page memory 6. In the second embodiment, the LST signal generated by the CIS scanning unit 17 is input to the image processing unit 34b via the first selector 31b, and the SCLK output from the CIS scanning unit 17 is input to the image processing unit 34b via the second selector 32b.

The processing carried out by the valid data extracting circuit 36b and the image processing circuit 37b is the same as the processing carried out on the image data of the reverse side by the valid data extracting circuit 36 and the image processing circuit 37 described above. Therefore, a detailed description will be omitted. In the second embodiment, the image processor 4b carries out a processing only on the image data of the reverse side scanned by the CIS scanning unit 17. Therefore, the register 29b stores the switching information 2 at all times, and the first selector 31b through the third selector 33b are not switched.

As described above, the image processor 4a is connected to the CCD line sensor 16, and the image processor 4b is connected to the CIS scanning unit 17. Accordingly, the image processing for the image data of the front side and the image processing for the image data of the reverse side of the original document scanned by the one-pass duplex scanning operation can be carried out concurrently.

Both the image processor 4a and the image processor 4b have the same configuration as the image processor 4. That is, the image processor 4a can control the scanning operation of the CIS scanning unit 17 and carry out an image processing on the image data of the reverse side scanned by the CIS scanning unit 17. The image processor 4b can control the scanning operation of the CCD line sensor 16 and carry out an image processing on the image data of the front side scanned by the CCD line sensor 16. Therefore, without changing the hardware configuration for the image processor 4a and the image processor 4b, the CCD line sensor 16 and the CIS scanning unit 17 can be controlled.

Further, the configuration of the image processing device 1 of the first embodiment and the configuration of the image processing device 1A of the second embodiment are just an example of the image processing device of the present invention, and can be modified appropriately without departing from the scope of the present invention. If the image processing device is a device having a function for scanning image data of both sides of an original document by asynchronous CCD line sensory and CIS scanning unit while transporting the original document in one direction, the image processing device may be, for example, a facsimile machine, a scanner or a multifunction peripheral having a facsimile function and a scanner function.

What is claimed is:

1. An image processing device, comprising:
a first scanning means for scanning image data of a front side of an original document;
a second scanning means for scanning image data of a reverse side of the original document; and
an image processor which carries out an image processing on the image data scanned by the first scanning means and the second scanning means;
wherein the image processor comprises:
an image processing means for extracting valid data from the scanned image data of one of the front side and the reverse side and carrying out a prescribed image processing;
means for generating a first line start signal as a standard of a scanning operation of the first scanning means;
a first inputting means for selectively inputting one of the first line start signal and a second line start signal to the image processing means, the second line start signal is a standard of a scanning operation of the second scanning means; and
a second inputting means for selectively inputting one of a first standard clock and a second standard clock to the image processing means, the first standard clock is a standard of a processing in which the first scanning means outputs the image data of the front side per pixel, and the second standard clock is a standard of a processing in which the second scanning means outputs the image data of the reverse side per pixel;
wherein the image processing means counts a number of the first standard clock for the image data of the front side on a basis of the first line start signal and extracts the valid data, and counts a number of the second standard clock for the image data of the reverse side on a basis of the second line start signal and extracts the valid data.

2. The image processing device according to claim 1, wherein an image processing for the image data of the front side scanned by the first scanning means and an image processing for the image data of the reverse side scanned by the second scanning means are carried out by a single image processor by time sharing.

3. The image processing device according to claim 1, comprising two image processors,
wherein the first scanning means is connected to one of the image processors and the second scanning means is connected to another one of the image processors,
the one of the image processors carries out a processing on the image data of the front side scanned by the first scanning means, and
the other one of the image processors carries out a processing on the image data of the reverse side scanned by the second scanning means.

4. The image processing device according to claim 3, wherein the processing on the image data of the front side by the one of the image processors and the processing on the image data of the reverse side by the other one of the image processors are carried out concurrently.

5. The image processing device according to claim 3, wherein the one of the image processors and the other one of the image processors have a same configuration.

6. The image processing device according to claim 1, wherein the image processor includes a register which stores switching information of the first inputting means and the second inputting means, and the first inputting means and the second inputting means are switched by rewriting the switching information of the register.

7. The image processing device according to claim 1, wherein the first scanning means and the second scanning means are different types of means for scanning.

8. The image processing device according to claim 7, wherein the first scanning means is a Charge-Coupled Device (CCD) line sensor and the second scanning means is a Contact Image Sensor (CIS) scanning unit.

9. The image processing device according to claim 1, wherein the first scanning means and the second scanning means have different capabilities regarding scanning speed.

10. A method of image processing comprising:
scanning image data of a front side of an original document;
scanning image data of a reverse side of the original document; and
extracting valid data from the scanned image data of one of the front side and the reverse side and carrying out a prescribed image processing;
generating a first line start signal as a standard of a scanning operation of the front side of the original document;
selectively inputting one of the first line start signal and a second line start signal, the second line start signal is a standard of a scanning operation of the reverse side of the original document;
selectively inputting one of a first standard clock and a second standard clock, the first standard clock is a standard of a processing in which image data of the front side is output per pixel, and the second standard clock is a standard of a processing in which image data of the reverse side is output per pixel;
counting a number of the first standard clock for the image data of the front side on a basis of the first line start signal and extracting the valid data; and
counting a number of the second standard clock for the image data of the reverse side on a basis of the second line start signal and extracting the valid data.
